(19) United States
(12) Patent Application Publication
(10) Pub. No.: US 2019/0197564 A1
(43) Pub. Date: Jun. 27, 2019

(54) PRODUCT SPACE REPRESENTATION MAPPING

(71) Applicant: INTERNATIONAL BUSINESS MACHINES CORPORATION, Armonk, NY (US)

(72) Inventors: Flavio du Pin Calmon, Cambridge, MA (US); Aditya Vempaty, Elmsford, NY (US); Ashish Jagmohan, Irvington, NY (US); Richard T. Goodwin, Dobbs Ferry, NY (US); Richard B. Segal, Chappaqua, NY (US)

(21) Appl. No.: 15/851,954

(22) Filed: Dec. 22, 2017

(51) Int. Cl. G06Q 30/02; G06F 17/30

(52) U.S. Cl. CPC G06Q 30/0201; G06F 17/30864; G06F 17/30241

(57) ABSTRACT

Embodiments of the present invention disclose a method, computer program product, and system for generating a special map of a plurality of products based on relationships between products. A query is received, from a user, via a user device, wherein the query includes an associated target product. A set of data associated with a plurality of products is received. An earth mover's distance value is calculating for at least one pair of products of the plurality of products. The earth mover's distance is communicated value to a user. A weight is received value based on a user input selection. The earth mover's distance value is modified based on the received weight. A flow vector is determining based on the modified earth mover's distance value of the at least one pair of products and each product of the at least one pair of products is mapped to a vector graph.

### BACKGROUND

The present invention relates generally to the field of data analytics, and more particularly to the generation of spatial relationship maps of products through statistical data analysis.

Organization may rely on expert-driven creative processes to formulate new products from existing infrastructure. For example, flavor companies depend on flavor experts to engage in trial-and-error processes to create and evaluate new flavors. In other industries, chemical companies that produce adhesives may rely on chemists to create new products based modification of existing adhesives to increase or decrease the adhesives' effectiveness. Relying on experts to generate new products may be a slow and labor-intensive process, therefore, it may be advantageous to determine relationships between existing products based on the ingredients of the products and analyze relationships between ingredients to formulate new products.

### SUMMARY

Embodiments of the present invention disclose a method, computer program product, and system for generating a special map of a plurality of products based on relationships between products. A query is received, from a user, via a user device, wherein the query includes an associated target product. A set of data associated with a plurality of products is received, wherein the plurality of products includes at least the target product, wherein each product of the plurality of products includes at least an ingredient. An Earth Mover's Distance value is calculating for at least one pair of products of the plurality of products, wherein the at least one pair of products includes the target product. The Earth Mover's Distance is communicated value to a user. A weight is received value based on a user input selection. The Earth Mover's Distance value is modified based on the received weight. A flow vector is determining based on the modified Earth Mover's Distance value of the at least one pair of products and each product of the at least one pair of products is mapped to a vector graph based on determined flow vector and associated at least one pair of products.

### BRIEF DESCRIPTION OF THE DRAWINGS

FIG. 1 is a functional block diagram illustrating a distributed data processing environment, in accordance with an embodiment of the present invention.

FIG. 2 is a functional block diagram illustrating the components of an application within the distributed data processing environment, in accordance with an embodiment of the present invention.

FIG. 3 is a flowchart depicting operational steps of an product distance application, on a server computer within the data processing environment of FIG. 1, in accordance with an embodiment of the present invention.

FIG. 4 depicts a block diagram of components of the server computer executing the product distance application, in accordance with an embodiment of the present invention.

### DETAILED DESCRIPTION

Embodiments of the present invention relate to the field of computing, and more particularly to the generation of spatial relationship maps of products through statistical data analysis. The following described exemplary embodiments provide a system, method, and program product to, among other things, calculate distance metric, the distance between pairs of products based on the ingredients or composition of the products within the pair of products, and generate a spatial map representing the products' relationship with one another. Therefore, the present embodiment has the capacity to improve the technical field of data analytics, data-driven model generation, or spatial map generation by generating recommendations for new products based on the calculated and mapped relationships between known products.

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Product experts are used in various fields to analyze an organization's product line and the current market to determine new products that would successfully take advantage of market trends or set new trends with the goal of positive sales. However, there is a limit in the creative avenues an expert can take, whether time or resources. Exploring all new products may be cost prohibitive or not feasible for human experts as the space of potential products is exponentially large due to the combinatorial nature of possible ingredient combinations and the creative limitations of product experts. Experts may create new products based on past experience, resulting in many products that occupy the same place in the product space. It may be advantageous to generate a map of products and the constituents of the products to determine similarities and differences between pairs of products that may aid in identifying desirable and undesirable product components, ingredients, or characteristics. It may also be advantageous to generate many unique combinations of new products that may not be similar to previous products but may be successful in the marketplace. A spatial relationship map can be used to mitigate the process of reinventing similar products where new trial products are similar to previous or discarded products.

It may also be advantageous to generate the spatial relationship map based on calculated distances between products, for example Earth Mover's Distance. The Earth Mover's Distance is a method to evaluate similarity or dissimilarity between two multi-dimensional distributions in some feature space where a distance measured between single features provided. Earth Mover's Distances between products may be used to solve linear program models trained on a combination of statistical data and expert feedback about products. Once the topology of the product space is determined, it can serve as a basis for creation of new products, either by a system that aids the expert in exploring this space, or automatically based on predetermined desired characteristics.

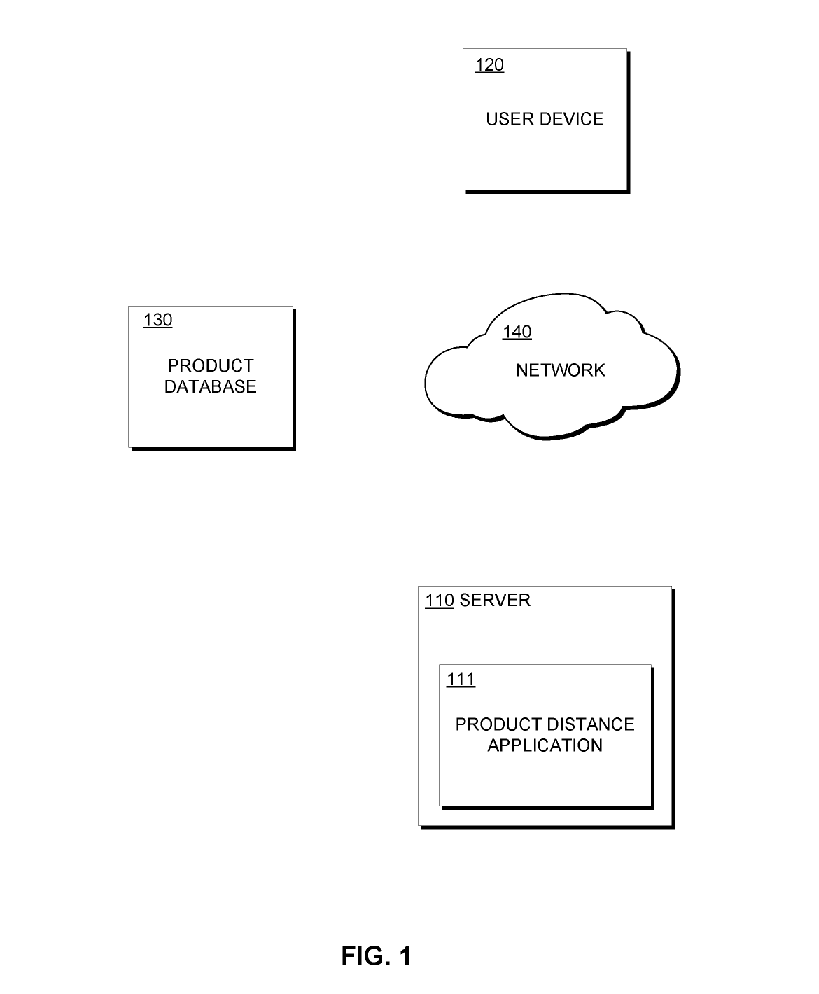

FIG. 1 is a functional block diagram illustrating a distributed data processing environment, generally designated 100, in accordance with one embodiment of the present invention. Distributed data processing environment 100 includes server 110, user device 120, and product database 130, all interconnected via network 140.

In various embodiments, network 140 can be, for example, a local area network (LAN), a wide area network (WAN) such as the Internet, or a combination of the two, and can include wired, wireless, or fiber optic connections. In general, network 140 can be any combination of connections and protocols that will support communications between server 110, user device 120, and product database 130.

In various embodiments, product database 130 may be any computer readable storage media accessible via network 140. Product database 130 may store an index of various products and components or ingredients associated with each product. In various embodiments, products are composed of a set of ingredients that are combined in some fashion (e.g., mixed, coupled, fastened, etc.) to form each product stored on product database 130. In various embodiments, the product may be a consumable product, for example, food or flavor profile, consisting of ingredients or flavors respectively.

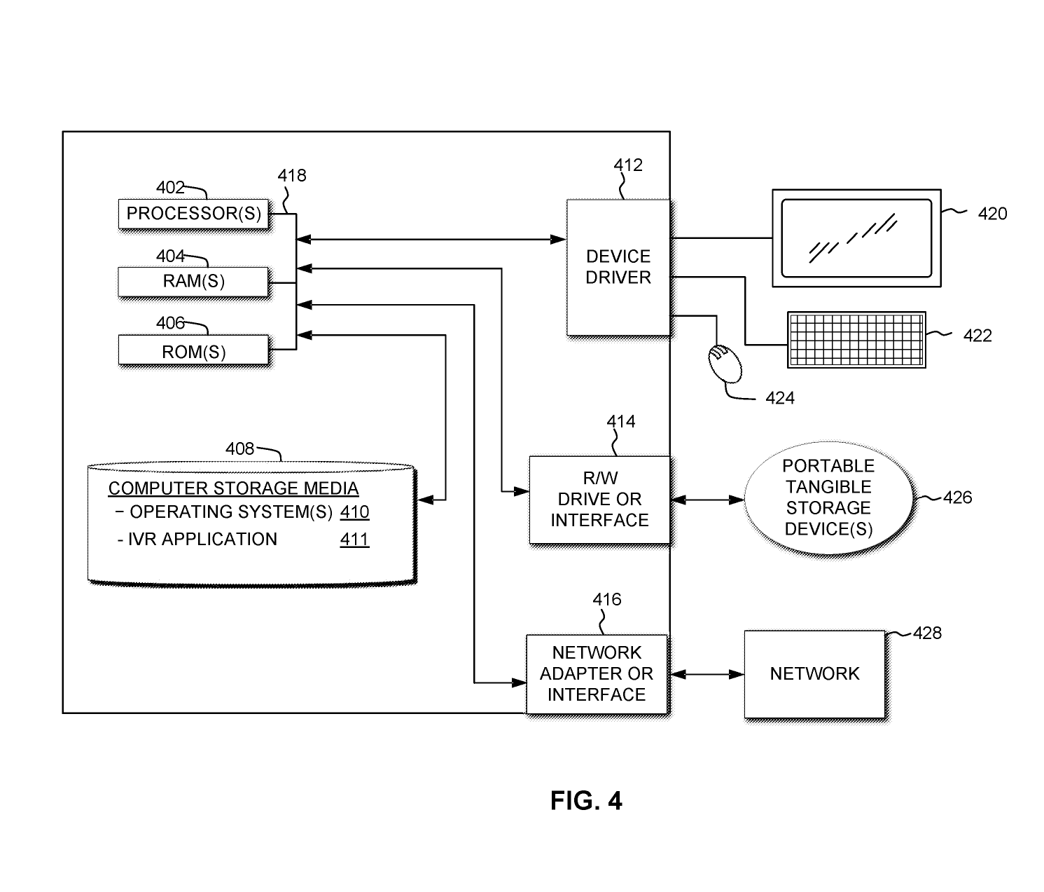

Server 110, user device 120, and product database 130 may be a laptop computer, tablet computer, netbook computer, personal computer (PC), a desktop computer, a smart phone, or any programmable electronic device capable of communicating via network, for example, network 140 and with various components and devices within distributed data processing environment 100. Server 110 includes product distance application 111. Product distance application 111 may communicate with user device 120 and product database 130. Server 110, user device 120, and product database 130 may include internal and external hardware components, as depicted and described in further detail with respect to FIG. 4.

It should also be noted, that processing for the product distance application 111 may be shared amongst the user device 120 and the server 110 in any ratio. In another embodiment, the product distance application 111 may operate on more than one server, user device, database, or some combination of servers, user devices, and databases, for example, a plurality of user devices 120 communicating across the network 140 with a single server 110. In another embodiment, for example, the product distance application 111 may operate on a plurality of servers 110 communicating across the network 140 with a plurality of user devices 120. Alternatively, the product distance application 111 may operate on a network server communicating across the network with server 110 and one or more user devices 120.

In various embodiments, product distance application 111 acts generally to use a combination of expert feedback (prompted or unprompted) and data to generate a spatial relationship map of a plurality of products. In various embodiments, product distance application 111 uses statistical data analysis of previously created products to determine a base topology of the relationship map space. In various embodiments, distances between products within the spatial relationship map are improved through (adaptive or non-adaptive) queries answered by product experts. For example, product distance application 111 may query user device 120, operated by a product expert, to confirm Product A and Product B are related and modify the relationship distance within the spatial relationship map based on the user selection input received by product distance application 111 via user device 120. In various embodiments, product distance application 111 receives a query from a user, for example, via user device 120. The received query may include a request for the comparative distances, or relationship neighborhood of a product and surrounding products.

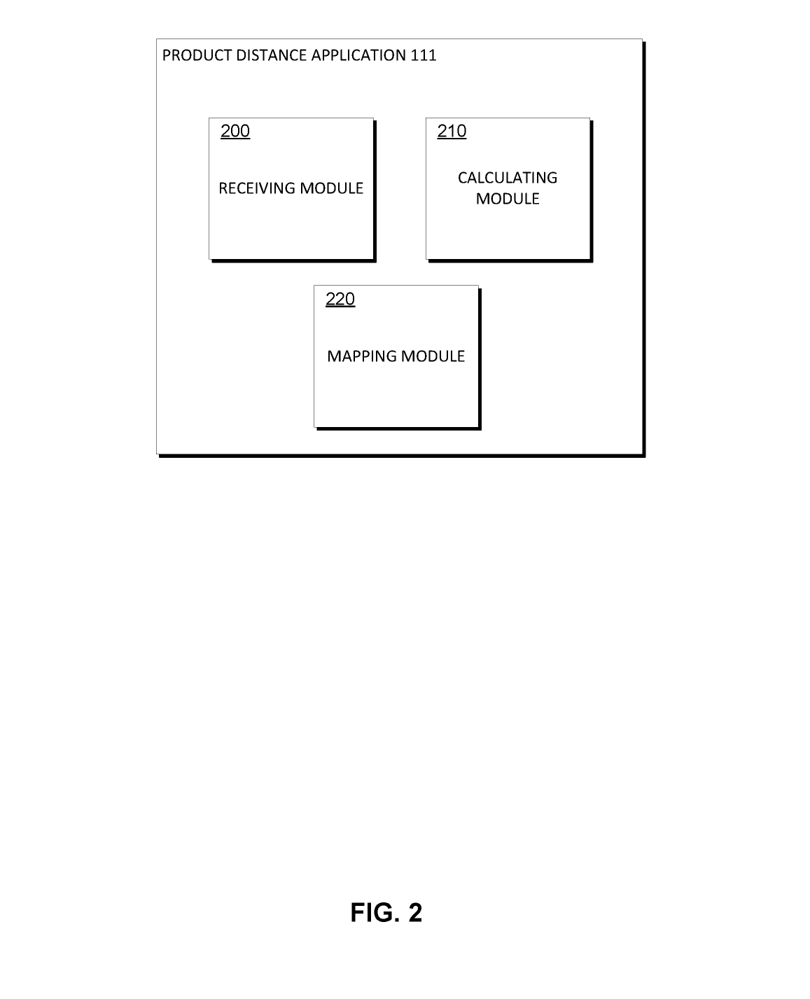

FIG. 2 is a functional block diagram illustrating the components of product distance application 111 within distributed data processing environment 100, in accordance with an embodiment of the present invention. Product distance application 111 includes receiving module 200, calculating module 210, and mapping module 220.

In reference to FIGS. 1 and 2, receiving module 200 may receive a query for a relationship distance, or neighborhood analysis for one or more target products or pairs of products. In various embodiments, receiving module 200 queries a database or series of databases, for example product database 130, for data associated with the target product and other products for analysis, for example the associated components or ingredients. In various embodiments, receiving module 200 communicates the target product(s) associated with the received query and the product data associated with the target product(s) to calculating module 210.

In various embodiments, calculating module 210 receives a target product(s) and associated product data from receiving module 200. Calculating module 210 may act generally to determine the Earth Mover's Distance between the target product and a plurality of products by solving a flow-constrained cost minimization linear program. Calculating module 210 may calculate the ground distance between ingredients of products taking products in pairs. In various embodiments, calculating module 210 calculates the initial ground distance based on a count of ingredient co-occurrence and ingredient context. Ingredient context may be predetermined, for example, metdata associated with an ingredient (honey) indicating one or more available substitutions (sugar, agave, or artificial sweetener) for the ingredient (honey) in a recipe. In various embodiments calculating module 210 calculates the initial ground distance and communicates a distance confirmation feedback query to user device 120. Calculating module 210 may receive user input via user device 120 and apply a weight on the initial ground distance based on the received user input.

In various embodiments, calculating module 210 calculates the Earth Mover's Distance using various algorithms to calculate the minimum linear program based on the weighted initial ground distance. In various embodiments, calculating module 210 may calculate the Earth Mover's Distance using the following linear complementarity quadratic program:

min Σᵢ∈ᵢ+δᵢ+α∥C∥₂²

s.t tr(C^{T}Fᵢ)≤dᵢ+∈ᵢ

rᵢ^{T}pᵢ+sᵢ^{T}qᵢ≥dᵢ−δᵢ

δᵢ,∈≥0 Formula 1

Where the linear complementarity quadratic program is solved for the minimum sum of an initial weight (εi) plus an initial change in distance (δi) plus the squared scaled Euclidian Vector Norm of the cost of flow matrix (C). Such that the trace of the cost flow matrix times the initial flow vector (C^{T}Fi) is less than or equal to the initial ground distance di plus the initial weight (εi) in a primal bound linear programming problem. The rate over a time period (r^{T}) of the first data cluster associated with a product (pi) plus the rate over a time period (s^{T}) of a second data cluster associated with a second product (qi) is greater than or equal to the initial distance minus the initial change in distance in a dual constraint problem. Both the initial weight and initial change in distance being greater than or equal to zero. In various embodiments, calculating module 210 communicates the calculated Earth Mover's Distance to mapping module 220.

In various embodiments, mapping module 220 may receive the calculated Earth Mover's Distances for a plurality of products from a target product from calculating module 210. Mapping module 220 may receive a predetermined distance threshold associated with a mapping query such that only products within the threshold are visualized. In various embodiments, mapping module 220 generated a visualization based on the calculated Earth Mover's Distance of the associated mapped products. For example, mapping module 220 may generate a vertex graph where the nodes are products and the edges are the calculated Earth Mover's Distances between products.

In various embodiments, mapping module 220 receives a query from user device 120 via product distance application 111 for a visualization of a new product relative to the mapped target product. Mapping module 220 may compare the received new product to the mapped set of products and return the closest products, or the products with the smallest Earth Mover's Distance values relative to the target product.

The combination of data driven model machine learning and expert feedback, for example, user input via user device 120 may increase the efficiency of the Earth Mover's Distance calculation over traditional algorithmic calculations that are purely data driven. In various embodiments, mapping module 220 may modify the mapped distances associated with the mapped products based on additional received queries.

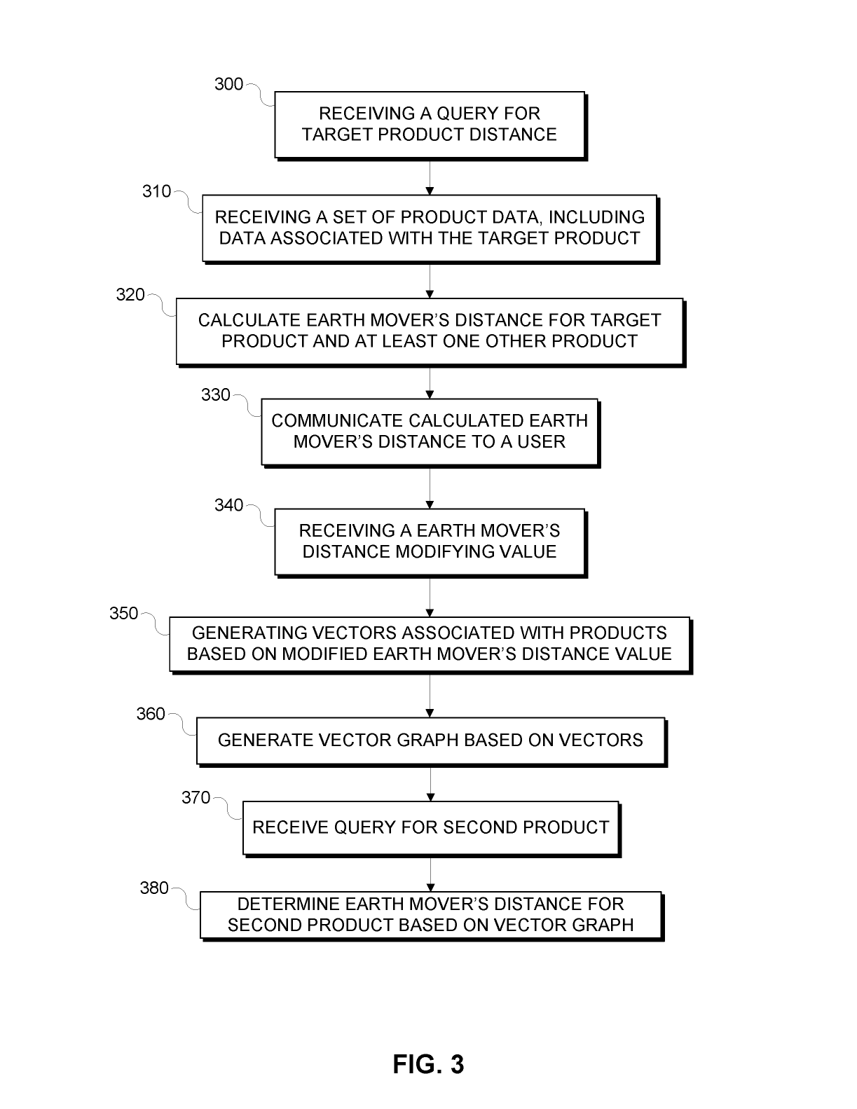

FIG. 3 is a flowchart depicting operational steps of product distance application 111, on a server computer within the data processing environment of FIG. 1, in accordance with an embodiment of the present invention.

In various embodiments, receiving module 200 receives a query from a user, for example, via user device 120 wherein the query includes an associated target product (block 300). Receiving module 200 queries a database, for example, product database 130, and receives data associated with a set of products, including the target product (block 310). In various embodiments, the data associated with each product includes one or more ingredients or components of the product.

Receiving module 200 communicates the target product query, products and associated data to calculating module 210. In various embodiments, calculating module 210 calculates the Earth Mover's Distance between the target product and product of the products received from receiving module 200 based on the associated data (block 320).

In various embodiments, calculating module 210 calculates the Earth Mover's Distance between two products based on an initially calculated ground distance between ingredients of the target product and each other received product based on the associated received product data. In various embodiments, calculating module 210 communicates the calculated Earth Mover's Distance to a user (block 330) via receiving module 200.

In various embodiments, calculating module 210 receives, via receiving module 200, user input selection modifying value the calculated Earth Mover's Distance between the target product and another product (block 330). The modifying value may be a positive or negative weight based on a user selection input, via user device 120. For example, the calculated Earth Mover's Distance is representative of the relationship between two products where, as the Earth Mover's distance between two products increases, the strength of the relationship, or the similarity of the two products, decreases. Calculating module 210 may receive a negative weight value for a associated with a communicated calculated Earth Mover's Distance value indicating the user disagreed with the calculated distance as two close, meaning the products are not as related or similar as calculated.

Calculating module 210 modifies the calculated Earth Mover's Distance values based on the received user input and generates vectors for the target product and each pairing received product based on the modified Earth Mover's Distance values between the target product and each paired product (block 350). Calculating module 210 communicates the generated vectors to mapping module 220.

In various embodiments, mapping module 220 receives Earth Mover's Distance values for the distances each product pair and the associated vectors. Mapping module 220 generates a vector graph based on the received vectors (block 360). In various embodiments, the vector graph contains nodes representing the products and edges representing the vectors based on the calculated Earth Mover's Distance.

In various embodiments, mapping module 220 receives a query, via receiving module 200, from a user, for example, via user device 120, for the Earth Mover's Distance of a second target product (block 370). In various embodiments, the second target product is a product that is paired with the target product or a new product. Mapping module 220 determines the Earth Mover's Distance value based on the generated vector graph and returns the value to the user.

In various embodiments, mapping module 220 may receive a query from a user for the Earth Mover's Distance of a product related to the target product. Mapping module 220 may determine the Earth Mover's Distance value of the product related to the target product based on the generated vector graph. Mapping module 220 may communicate the requested Earth Mover's Distance value to the user.

It should be appreciated that, in various embodiments, at any time, the calculated Earth Mover's Distance values or generated vectors may be communicated by one or more modules within product distance application 111 to a user. In response to receiving a weight value based on a user input selection the associated Earth Mover's Distance value may be modified.

FIG. 4 depicts a block diagram of components of server 110, user device 120, and product database 130 of distributed data processing environment 100 of FIG. 1, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

Server 110, user device 120, and product database 130 may include one or more processors 402, one or more computer-readable RAMs 404, one or more computer-readable ROMs 406, one or more computer readable storage media 408, device drivers 412, read/write drive or interface 414, network adapter or interface 416, all interconnected over a communications fabric 418. Communications fabric 418 may be implemented with any architecture designed for passing data and/or control information between processors (such as microprocessors, communications and network processors, etc.), system memory, peripheral devices, and any other hardware components within a system.

One or more operating systems 410, and one or more application programs 411, for example, product distance application 111, are stored on one or more of the computer readable storage media 408 for execution by one or more of the processors 402 via one or more of the respective RAMs 404 (which typically include cache memory). In the illustrated embodiment, each of the computer readable storage media 408 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Server 110, user device 120, and product database 130 may also include a R/W drive or interface 414 to read from and write to one or more portable computer readable storage media 426. Application programs 411 on server 110, user device 120, and product database 130 may be stored on one or more of the portable computer readable storage media 426, read via the respective R/W drive or interface 414 and loaded into the respective computer readable storage media 408.

Server 110, user device 120, and product database 130 may also include a network adapter or interface 416, such as a TCP/IP adapter card or wireless communication adapter (such as a 4G wireless communication adapter using OFDMA technology) for connection to a network 428. Application programs 411 on server 110, user device 120, and product database 130 may be downloaded to the computing device from an external computer or external storage device via a network (for example, the Internet, a local area network or other wide area network or wireless network) and network adapter or interface 416. From the network adapter or interface 416, the programs may be loaded onto computer readable storage media 408. The network may comprise copper wires, optical fibers, wireless transmission, routers, firewalls, switches, gateway computers and/or edge servers.

Server 110, user device 120, and product database 130 may also include a display screen 420, a keyboard or keypad 422, and a computer mouse or touchpad 424. Device drivers 412 interface to display screen 420 for imaging, to keyboard or keypad 422, to computer mouse or touchpad 424, and/or to display screen 420 for pressure sensing of alphanumeric character entry and user selections. The device drivers 412, R/W drive or interface 414 and network adapter or interface 416 may comprise hardware and software (stored on computer readable storage media 408 and/or ROM 406).

In various embodiments, product distance application 111 may implement machine learning. The set of product data received by product distance application 111 may be used as the training data for calculating distances and the Earth Mover's Distances calculated by a model may be confirmed with expert feedback or an administrator, via user device 120. After the Earth Mover's Distance model is trained additional queries with associated target products, additional products, and product data are received can be used as a test case.

In various embodiments, product distance application 111 calculates a relationship score for each product paired with the target product based on the length of the edge between respective nodes of the generated vector graph. The vector graph may be modified or filters based on user input selection of viewing nodes that cross a threshold relationship score. A query to view only nodes with an associated relationship score within a desired range may be received by product distance application 111. In various embodiments, a query with a new target product is received by product distance application 111. Product distance application 111 modifies the generated vector map based on the relationship scores and may display products with relationship scores within the received range.

In various embodiments, product distance application 111 receives a threshold value from the user, via user device 120. Product distance application 111 calculates the Earth Mover's Distance value between each product of the plurality of products and the target product and generates an ordered list where the order of the products in the list is based on the Earth Mover's distance value. To increase efficiency, product distance application 111 may generate the vector graph only including a number, or count, of products not exceeding the received threshold. In various embodiments, the threshold may be the number of products included in the vector graph, the desired Earth Mover's Distance range, or any other value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Based on the foregoing, a computer system, method, and computer program product have been disclosed. However, numerous modifications and substitutions can be made without deviating from the scope of the present invention. Therefore, the present invention has been disclosed by way of example and not limitation.

What is claimed is:

1. A method for generating a special map of a plurality of products based on relationships between products of the plurality of products, the method comprising:
receiving a query, from a user, via a user device, wherein the query includes an associated target product;
receiving a set of data associated with a plurality of products, wherein the plurality of products includes at least the target product, wherein each product of the plurality of products includes at least an ingredient;
calculating an Earth Mover's Distance value for at least one pair of products of the plurality of products, wherein the at least one pair of products includes the target product;
communicating the Earth Mover's Distance value to a user;
receiving a weight value based on a user input selection;
modifying the Earth Mover's Distance value based on the received weight;
determining a flow vector based on the modified Earth Mover's Distance value of the at least one pair of products; and
mapping each product of the at least one pair of products to a vector graph based on determined flow vector and associated at least one pair of products.

2. The method of claim 1, further comprising:
calculating a relationship score for each product of the mapped at least one pair of products;
receiving a second query, wherein the second query includes a second target product;
calculating an Earth Mover's Distance value for the second target product and the target product;
mapping the second target product to the vector graph; and
calculating a relationship score for the second target product based on the modified vector graph.

3. The method of claim 1, wherein calculating an Earth Mover's Distance value is based on a linear optimization program minimum value of the at least one product pair.

4. The method of claim 1, further comprising:
receiving a threshold value from the user via the user device;
calculating an Earth Mover's Distance value between each product of the plurality of products and the target product;
generating an ordered list of each product of the plurality of products, wherein the ordered list is organized based on the associated calculated Earth Mover's Distance; and
mapping a count of products of the plurality of products, wherein the count of products of the plurality of products does not exceed the received threshold value.

5. The method of claim 1, wherein the weight value is determined through machine learning analysis.

6. The method of claim 1, further comprising:
calculating a ground distance value for each ingredient of each product of the at least one pair of products; and
calculating and Earth Mover's Distance value based on the calculated ground distance of each ingredient of each product of the at least one pair of products.

7. A computer program product for generating a special map of a plurality of products based on relationships between products of the plurality of products, the computer program product comprising:
one or more computer-readable storage media and program instructions stored on the one or more computer-readable storage media, the program instructions comprising:
instructions to receive a query, from a user, via a user device, wherein the query includes an associated target product;
instructions to receive a set of data associated with a plurality of products, wherein the plurality of products includes at least the target product, wherein each product of the plurality of products includes at least an ingredient;
instructions to calculate an Earth Mover's Distance value for at least one pair of products of the plurality of products, wherein the at least one pair of products includes the target product;
instructions to communicate the Earth Mover's Distance value to a user;
instructions to receive a weight value based on a user input selection;
instructions to modify the Earth Mover's Distance value based on the received weight;
instructions to determine a flow vector based on the modified Earth Mover's Distance value of the at least one pair of products; and
instructions to map each product of the at least one pair of products to a vector graph based on determined flow vector and associated at least one pair of products.

8. The computer program product of claim 7, further comprising:
instructions to calculate a relationship score for each product of the mapped at least one pair of products;
instructions to receive a second query, wherein the second query includes a second target product;
instructions to calculate an Earth Mover's Distance value for the second target product and the target product;
instructions to map the second target product to the vector graph; and
instructions to calculate a relationship score for the second target product based on the modified vector graph.

9. The computer program product of claim 7, wherein calculating an Earth Mover's Distance value is based on a linear optimization program minimum value of the at least one product pair.

10. The computer program product of claim 7, further comprising:
instructions to receive a threshold value from the user via the user device;
instructions to calculate an Earth Mover's Distance value between each product of the plurality of products and the target product;
instructions to generate an ordered list of each product of the plurality of products, wherein the order is based on the associated calculated Earth Mover's Distance; and
instructions to map a count of products of the plurality of products, wherein the count does not exceed the received threshold value.

11. The computer program product of claim 7, wherein the weight value is determined through machine learning analysis.

12. The computer program product of claim 7, further comprising:
instructions to calculate a ground distance value for each ingredient of each product of the at least one pair of products; and
instructions to calculate and Earth Mover's Distance value based on the calculated ground distance of each ingredient of each product of the at least one pair of products.

13. A computer system for generating a special map of a plurality of products based on relationships between products of the plurality of products, the computer system comprising:
one or more computer processors;
one or more computer-readable storage media;
program instructions stored on the computer-readable storage media for execution by at least one of the one or more processors, the program instructions comprising:
instructions to receive a query, from a user, via a user device, wherein the query includes an associated target product;
instructions to receive a set of data associated with a plurality of products, wherein the plurality of products includes at least the target product, wherein each product of the plurality of products includes at least an ingredient;
instructions to calculate an Earth Mover's Distance value for at least one pair of products of the plurality of products, wherein the at least one pair of products includes the target product;
instructions to communicate the Earth Mover's Distance value to a user;
instructions to receive a weight value based on a user input selection;
instructions to modify the Earth Mover's Distance value based on the received weight;
instructions to determine a flow vector based on the modified Earth Mover's Distance value of the at least one pair of products; and
instructions to map each product of the at least one pair of products to a vector graph based on determined flow vector and associated at least one pair of products.

14. The computer program product of claim 13, further comprising:
instructions to calculate a relationship score for each product of the mapped at least one pair of products;
instructions to receive a second query, wherein the second query includes a second target product;
instructions to calculate an Earth Mover's Distance value for the second target product and the target product;
instructions to map the second target product to the vector graph; and
instructions to calculate a relationship score for the second target product based on the modified vector graph.

15. The computer program product of claim 13, wherein calculating an Earth Mover's Distance value is based on a linear optimization program minimum value of the at least one product pair.

16. The computer program product of claim 13, further comprising:
instructions to receive a threshold value from the user via the user device;
instructions to calculate an Earth Mover's Distance value between each product of the plurality of products and the target product;
instructions to generate an ordered list of each product of the plurality of products, wherein the order is based on the associated calculated Earth Mover's Distance; and
instructions to map a count of products of the plurality of products, wherein the count does not exceed the received threshold value.

17. The computer program product of claim 13, wherein the weight value is determined through machine learning analysis.

18. The computer program product of claim 13, further comprising:
instructions to calculate a ground distance value for each ingredient of each product of the at least one pair of products; and
instructions to calculate and Earth Mover's Distance value based on the calculated ground distance of each ingredient of each product of the at least one pair of products.
